(19) United States
(12) Patent Application Publication
(10) Pub. No.: US 2026/0146700 A1
(43) Pub. Date: May 28, 2026

(54) DROP-ON, SLIDE-OUT MOUNT

(71) Applicant: GCX Corporation, Petaluma, CA (US)

(72) Inventors: Robert Peter Glaser, Corte Madera, CA (US); Paul Rene Borloz, Petaluma, CA (US)

(21) Appl. No.: 18/959,380

(22) Filed: Nov. 25, 2024

(51) Int. Cl. F16M 11/04; F16M 11/10

(52) U.S. Cl. CPC F16M 11/041; F16M 11/10

(57) ABSTRACT

A drop-on and slide-out function is provided for mounting a device, such as healthcare and IT devices to a stand, arm, or the like. The drop-on (snap in) function addresses the need for quick, easy, safe, and reliable device mounting. A slide-out function, with indexing plunger pin, addresses the need for safety and protection against accidental dismounting. An audible (click) and visual cues provide feedback for proper use.

### TECHNICAL FIELD

Various of the disclosed embodiments concern a drop-on, slide-out mount.

### BACKGROUND

State of the art equipment mounts, e.g., those that are used to mount devices such as medical devices, monitors, and the like, to an equipment stand, arm, or the like typically accept an adapter plate that is installed on the device. The adapter plate is usually a thin piece of sheet metal. To attach the device to the mount the adapter plate is slid into the mount via openings in the side of the mount and along narrow, parallel channels provided along the mount which receive, guide, and retain the device, thus mating the device to the mount.

It is difficult and sometimes dangerous to attempt to mount a heavy and cumbersome device, such as a monitor, to a support arm using the adapter plate on the device. First, the user must align the adapter plate with the parallel channels of the mount, while maintaining the plane of the mount parallel to that of the adapter plate, and while supporting the device and holding the device steady. The user must then slide the adapter plate into the channels while simultaneously pulling down a spring loaded pin to secure the device to the support, again while supporting the device and holding it steady.

It would be advantageous to provide a quick, easy, safe, and reliable system for mounting devices, such medical devices, IT equipment, and the like to, for example, support arms and equipment stands.

### SUMMARY

Embodiments of the invention provide a drop-on and slide-out function for mounting a device, such as a healthcare or IT device to an equipment stand, arm, or the like. The drop-on (snap in) function addresses the need for quick, easy, safe, and reliable device mounting. A slide-out function, with an indexing plunger pin, addresses the need for safety and protection against accidental dismounting. An audible (click) and visual cues provide feedback for proper use.

### BRIEF DESCRIPTION OF THE DRAWINGS

FIG. 1 is a schematic side view of a device adapter and drop-on, slide-off mount according to an embodiment of the invention;

FIG. 2 is a schematic side view of a drop-on, slide-off mount according to an embodiment of the invention;

FIG. 3 is a partial cutaway, schematic side view of a plunger for a drop-on, slide-off mount according to an embodiment of the invention;

FIGS. 4A-4D show the engagement of a device with a support arm via a drop-on, slide-off mount according to an embodiment of the invention;

FIGS. 5A-5C show front and rear latch operation of a drop-on, slide-off mount according to an embodiment of the invention;

FIGS. 6A and 6B show operation of an indexing plunger pin for a drop-on, slide-off mount according to an embodiment of the invention;

FIG. 7 is a perspective schematic view of a drop-on, slide-off mount with an adapter plate secured thereto according to an embodiment of the invention; and

FIGS. 8A-8C show removal of a mounting pale from a drop-on, slide-off mount according to an embodiment of the invention.

### DETAILED DESCRIPTION

Embodiments of the invention provide a drop-on and slide-out function for mounting a device, such as a healthcare or IT device to an equipment stand, arm, or the like. The drop-on (snap in) function addresses the need for quick, easy, safe, and reliable device mounting. A slide-out function, with an indexing plunger pin, addresses the need for safety and protection against accidental dismounting. An audible (click) and visual cues provide feedback for proper use.

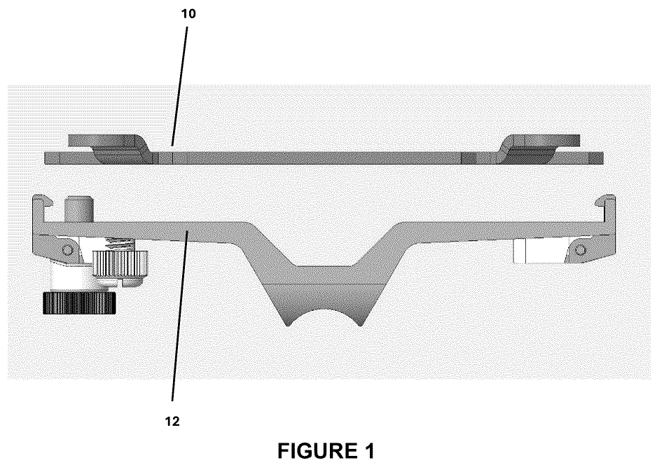

FIG. 1 is a schematic side view of a device adapter and drop-on, slide-off mount according to an embodiment of the invention. In FIG. 1 a device adapter 10 is shown in a spaced relation to a drop-on, slide-off mount 12. The device adapter is made typically made of steel, aluminum, composites, or other such materials; the drop-on, slide-off mount is typically made of aluminum, steel, and composites, but may be made of other suitable materials in other embodiments of the invention.

Those skilled in the art will appreciate that the invention is readily used with a device that incorporates a mounting plate into its base instead of requiring a separate adapter. In such case, the device itself is mounted directly to the drop-on, slide-off mount by engaging the device base into the drop-on, slide-off mount.

Unlike known mounts, the herein disclosed drop-on, slide-off mount allows the user to simply drop the device unto the mount where it snaps into secure engagement with the mount.

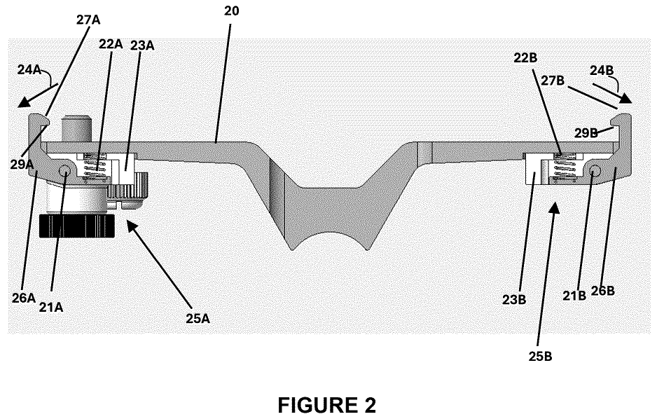

FIG. 2 is a schematic side view of a drop-on, slide-off mount according to an embodiment of the invention. In FIG. 2, a mounting base 20 includes a pair of spaced, opposing latch assemblies 25A, 25B. The latch assemblies are each held in a respective latch base 23A, 23B and each includes a respective biasing spring 22A, 22B, and a respective latch arm 26A, 26B that is displaced about a respective pivot point 21A, 21B in the direction shown by arrows 24A, 24B when engaged with a device adapter.

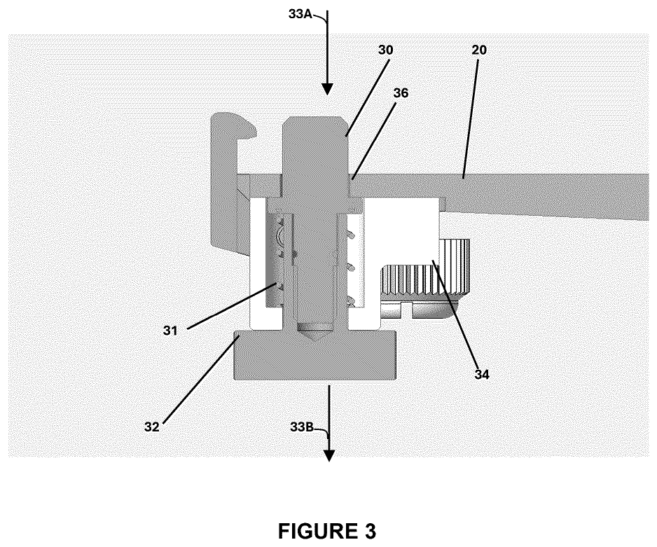

The latches are both sprung in the closed position. The latch arms each have a respective inwardly, downwardly sloping upper surface 27A, 27B along which the adapter plate is guided as it is lowered on the drop-on, slide-off mount. As the adapter plate is lowered onto the drop-on, slide-off mount the latch arms are pushed outwardly. As a result, the latch arms are driven open by the adapter plate (on device) as it is dropped down towards the mounting plate surface. Once the adapter plate abuts mounting plate the two latches close and a lower surface 29A, 29B of latch arms captures the plate up and down. An indexing plunger is then engaged with the plate to capture the adapter plate side to side (see FIG. 3).

Those skilled in the art will appreciate that embodiments of the invention may comprise a single latch assembly in which the adapter plate is first engaged in a channel formed in the drop-on, slide-off mount, after which the adapter plate is pressed downwardly onto the base to displace a latch arm outwardly such that the adapter plate drops onto and snaps into the drop-on, slide-off mount.

FIG. 3 is a partial cutaway, schematic side view of an indexing plunger assembly for a drop-on, slide-off mount according to an embodiment of the invention. In FIG. 3, a plunger pin 30 protrudes through an aperture 36 formed in the mount base 20. The plunger pin is biased upwardly through the mount base by a plunger spring 31. The plunger pin is withdrawn through the aperture of the base plate by operation of a plunger knob 32 and latch block 34.

The plunger pin is sprung in the closed position with the plunger pin protruding from mount plate surface. The plunger pin is used to capture the adapter plate on the device laterally within the mounting plate. Pulling the plunger knob down retracts the plunger pin to the subsurface of the mount, as shown by arrows 33A and 33B, which allows the adapter plate to be slid laterally out of the mount.

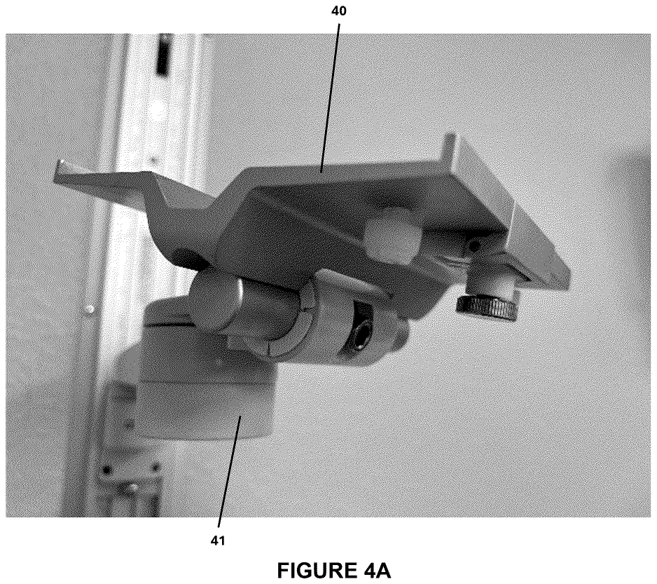

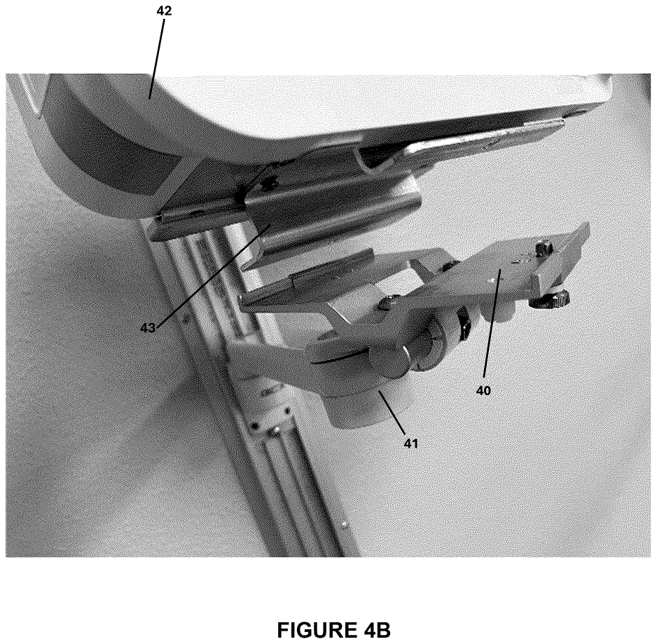

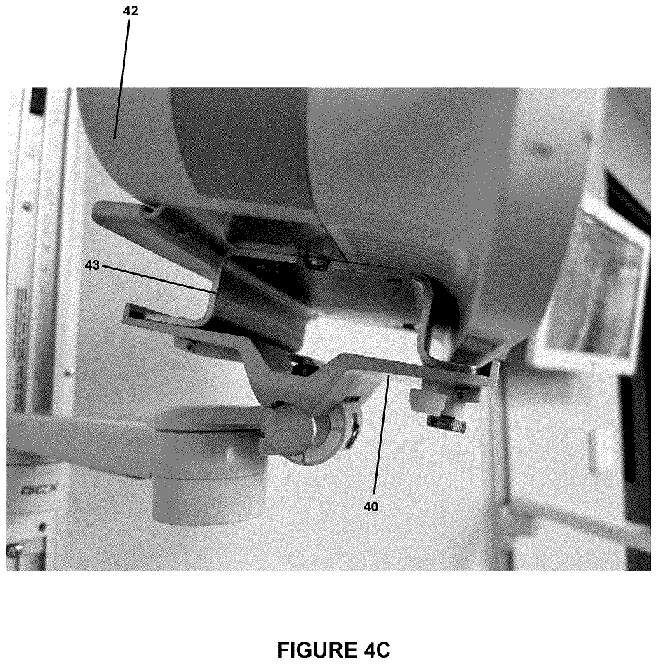

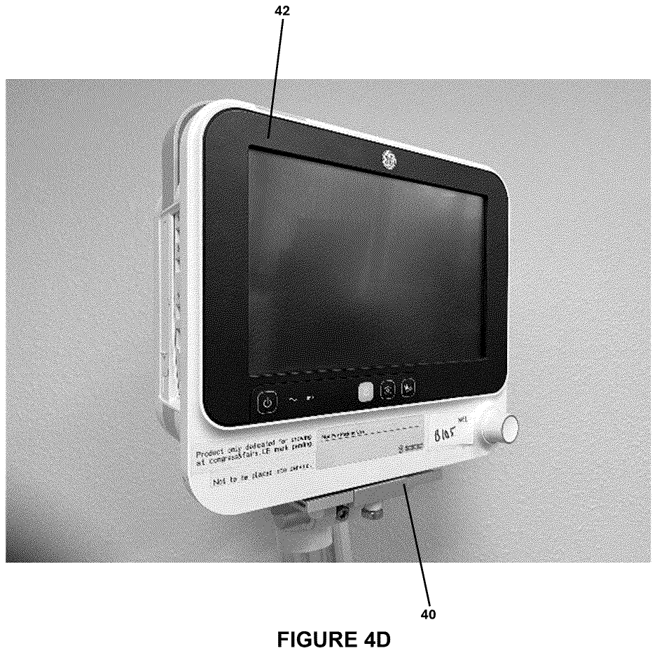

FIGS. 4A-4D show the engagement of a device with a support arm via a drop-on, slide-off mount according to an embodiment of the invention.

FIG. 4A shows a drop-on, slide-off mount 40 attached to a device arm 41. Those skilled in the art will appreciate that the herein disclosed a drop-on, slide-off mount is readily adapted for attachment to any device support including, but not limited to, a cart, an arm, a table, a wall bracket, a vehicle, a bed, a chair, a device associated with the device to be mounted, a shelf, a counter, a cabinet, etc.

FIG. 4B shows the device 42 and adapter plate 43 being lowered onto the drop-on, slide-off mount 40.

FIG. 4C shows the device 42 and adapter plate 43 engaged with the drop-on, slide-off mount 40.

FIG. 4D shows the device 42 ready to use.

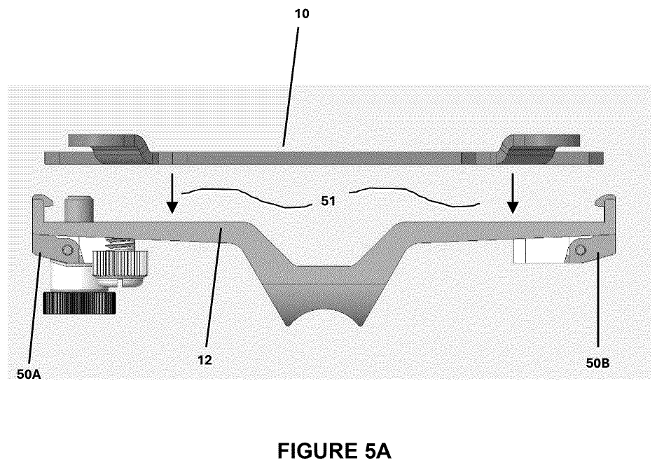

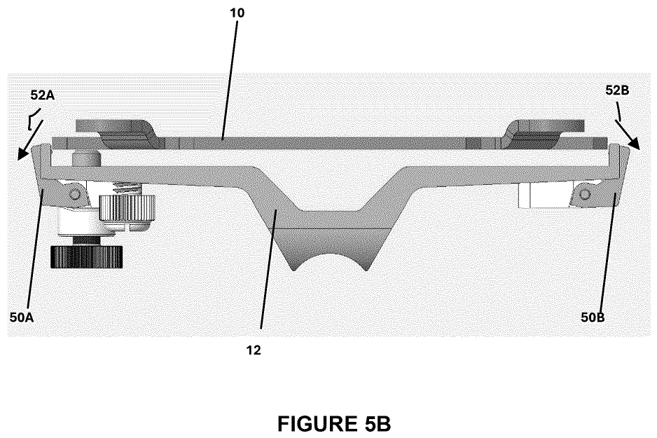

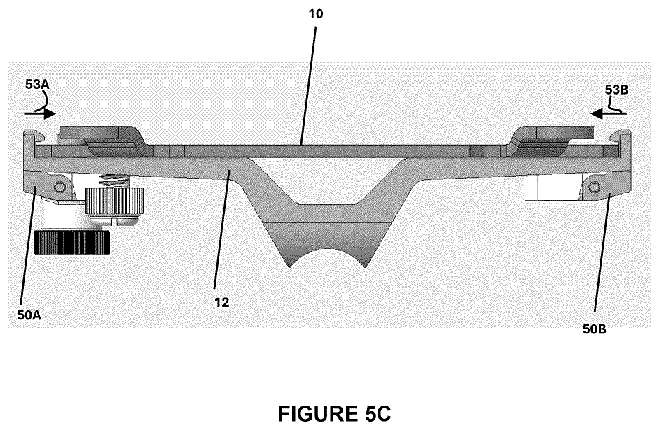

FIGS. 5A-5C show front and rear latch operation of a drop-on, slide-off mount according to an embodiment of the invention.

In FIG. 5A, the latches 50A, 50B are sprung closed as the adapter plate 10 is lowered down onto the drop-on, slide-off mount 12, as shown by the arrow 51.

In FIG. 5B, the adapter plate 10 contacts the latches 50A, 50B to force them open, as shown by arrows 52A, 52B. Note that the latches can open individually or simultaneously. The adapter plate does not need to be perfectly oriented to seat the device properly.

In FIG. 5C, the adapter plate 10 is fully seated on the drop-on, slide-off mount 12. The latches 50A, 50B spring closed, as shown by arrows 53A, 53B, with an audible “click,” thus confirming that the device is securely seated on the drop-on, slide-off mount.

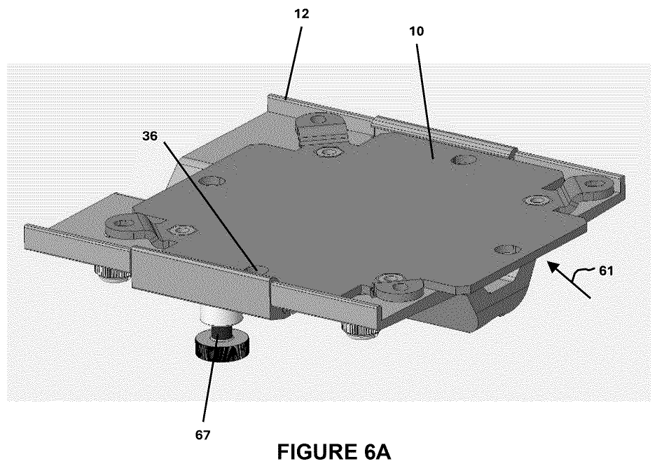

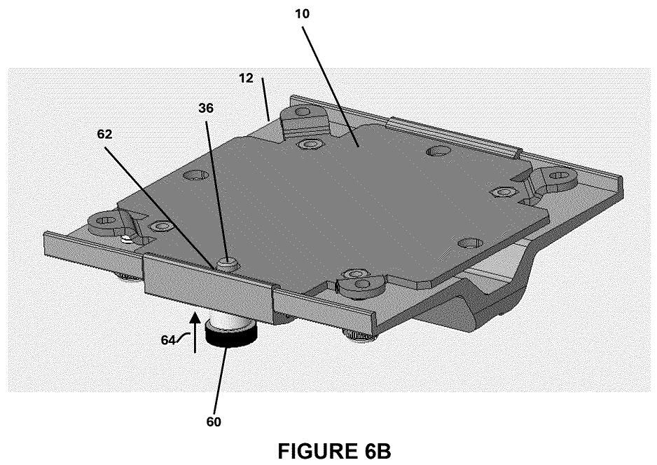

FIGS. 6A and 6B show operation of an indexing plunger for a drop-on, slide-off mount according to an embodiment of the invention.

In FIG. 6A, a visual cue 67, such as a red indicator or other such indicator, is displayed if the adapter plate is engaged with the latches, but not with the plunger pin. As the adapter plate is slid along the channels defined by the drop-on, slide-off mount latches, as shown by arrow 61 an aperture 36 formed in the adapter plate is moved toward engagement with the plunger pin.

In FIG. 6B, the device attached to adapter plate is slid laterally to engage the plunger pin 63. Once the plunger pin is engaged with the aperture 36 formed in the adapter plate, the plunger springs closed with an audible “click” and the visual cue disappears. The plunger pin secures to adapter plate (device) laterally in the drop-on, slide-off mount. In other embodiments of the invention thumbscrews or other mechanisms (not shown) may be used to remove all clearances to prevent rattling.

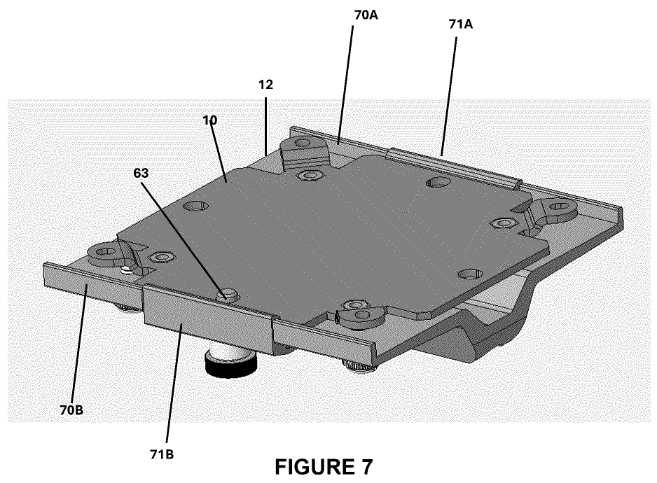

FIG. 7 is a perspective schematic view of a drop-on, slide-off mount with an adapter plate secured thereto according to an embodiment of the invention. In FIG. 7, the latches 71A, 71B provide vertical retention of the adapter plate. The plunger pin 63 provides left/right lateral retention of the adapter plate. The fixed walls 70A, 70B of the drop-on, slide-off mount provide front/rear lateral retention of the adapter plate. The latches capture the adapter plate up/down. The fixed walls capture the adapter plate front/back. Without the fixed walls, the adapter plate would be able to push and spring the latches. The fixed walls prevent the adapter plate from pushing laterally on the latches and inadvertently opening them. In normal use the latches cannot be opened. In this condition, the device is secured and safely mounted. It cannot be dismounted without deliberately disengaging the plunger pin and sliding the device laterally out from under the latches.

Accordingly, each latch forms a channel using the base horizontal surface, capturing the adapter plate vertically. The two vertical walls and the horizontal surface of the mount base create a vertical channel capturing the plate front/back. Sliding past the latch allows the adapter plate to disengage upward and out. The adapter plate does not need to slide all the way past the base plate walls to disengage from the base.

One important feature of the invention is the safety it provides. The device cannot be inadvertently dis-mounted. Additionally, the need to slide the device laterally out of the mount ensures that the user has at least one hand holding and controlling the device and furthermore naturally induces the use of two hands. This promotes the condition of the user being in control of the device during dismount.

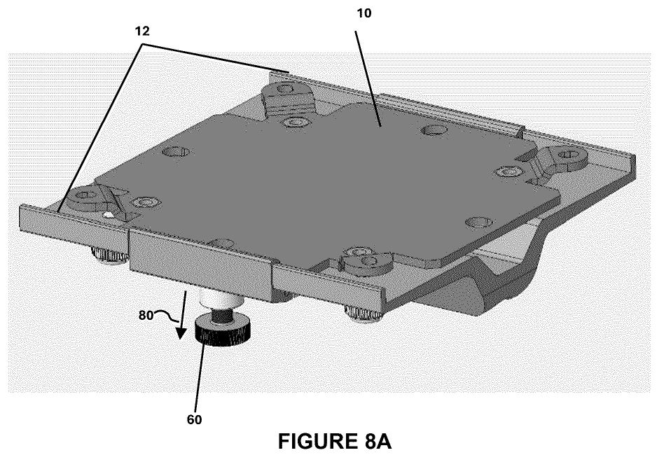

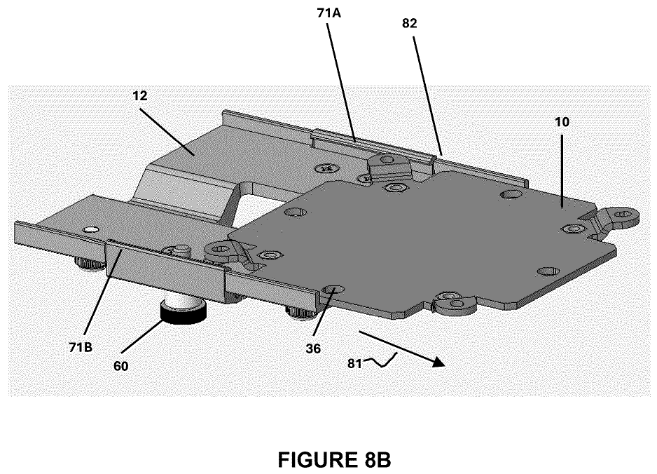

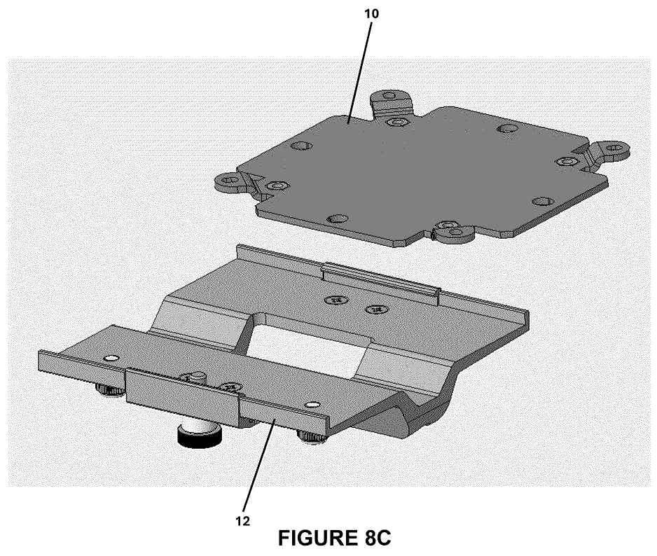

FIGS. 8A-8C show removal of a mounting plate from a drop-on, slide-off mount according to an embodiment of the invention.

In FIG. 8A, the plunger pin knob 60 is pulled down, as shown by the arrow 80, to release adapter plate 10. The user can then begin sliding the adapter plate laterally left or right, guided by the fixed walls 12. The plunger pin can be released after it is no longer centered on the aperture 36 (see FIGS. 3 and 8B) because the plunger tip then bears against the underside of the adapter plate.

In FIG. 8B, the user can continue sliding the adapter plate 10 out from the drop-on, slide-off mount 12 until the adapter plate is free of the latches 71A, 71B. The plunger pin springs back to a closed position once it is clear of the adapter plate.

In FIG. 8C the device that is attached to the adapter plate 10 is then removed from the drop-on, slide-off mount 12.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

I/We claim:

1. A mount, comprising:
a mount base; and
at least one latch comprising a latch arm projecting substantially vertically from said mount base;
wherein said latch arm is inwardly biased and comprises an inwardly facing, downwardly sloping upper face;
wherein downward engagement of a device adapter plate or base with said inwardly facing, downwardly sloping upper face pivots said latch arm outwardly;
wherein a device associated with said adapter plate or base is affixed to said mount by positioning said adapter plate or base downwardly substantially parallel to and into contact with an upper surface of said mount base;
wherein during said downward positioning, said adapter plate or base moves downwardly past said inwardly facing, downwardly sloping upper face of said latch arm;
wherein said adapter plate or base contacts said mount base upper surface;
wherein said latch arm pivots inwardly; and
wherein an outwardly projecting lower surface of said latch arm captures said adapter plate or base securing said adapter plate or base to said mount base.

2. The mount of claim 1, wherein said adapter plate or base is associated with a device.

3. The mount of claim 1, wherein said mount is adapted to mount to any of an equipment stand, arm, or the like.

4. The mount of claim 1, wherein an audible cue is generated when said adapter plate or base engages with said mount base upper surface.

5. The mount of claim 1, wherein said mount base comprises two substantially vertical, spaced, parallel walls positioned along respective opposite edges of said mount base to create a channel adapted to retain said adapter plate or base thereto;
wherein each of said channel walls comprises at least one open end; and
wherein said adapter plate or base, when secured to said base plate, is slidable across said base plate upper surface along said channel walls past at least one latch to disengage said adapter plate or base from said mount base.

6. The mount of claim 5, wherein at least one of said two substantially vertical, spaced, parallel channel walls comprises one of said latch arm.

7. The mount of claim 1, further comprising:
an upwardly biased, moveable plunger pin projecting upwardly from said base plate;
wherein said plunger pin is adapted to engage with a complementary aperture formed in said adapter plate or base;
wherein engagement of said plunger pin with said aperture secures said adapter plate or base against translational movement relative to said base plate; and
wherein said plunger pin is adapted for selective withdrawal from said aperture to release said adapter plate or base from said base plate.

8. The mount of claim 7, said plunger pin further comprising:
a visual cue for providing feedback indicating engagement and disengagement of said plunger pin with said aperture.

9. A drop-on, slide-off mount, comprising:
a mounting base comprising:
a pair of spaced, opposing latch assemblies, wherein the latch assemblies are each held in a respective latch base, each latch assembly comprising a respective biasing spring and a respective latch arm that is displaceable about a respective pivot point when engaged with a device affixed to or having an adapter plate, each latch arm comprising a respective inwardly, downwardly sloping upper surface, each latch arm comprising an outwardly projecting lower surface adapted to capture said adapter plate;
wherein when the device is lowered unto the drop-on, slide-off mount:
the latch arms are initially both sprung in a closed position;
the device affixed to or having the adapter plate is guided the along the respective inwardly, downwardly sloping upper surface of each latch arm as it is lowered onto the drop-on, slide-off mount;
the latch arms are pushed outwardly; and
when the adapter plate abuts the mounting base the two latch arms close capturing adapter plate up and down into secure engagement with the drop-on, slide-off mount.

10. The drop-on, slide-off mount, further comprising:
an indexing pin selectively engageable with a complementary aperture formed in the adapter plate to capture the adapter plate side to side when the adapter plate abuts the mounting base.

11. The drop-on, slide-off mount, said indexing pin further comprising;
a plunger pin adapted to protrude through said aperture when said aperture is aligned with said plunger pin;
a plunger spring adapted to bias said plunger pin upwardly through said aperture when said aperture is aligned with said plunger pin;
a plunger knob adapted to withdraw said plunger pin from said aperture to release said adapter plate from said drop-on, slide-off mount.

12. The drop-on, slide-off mount of claim 8, wherein the latch arms are operable individually or simultaneously; and
wherein adapter plate or base does not need to be perfectly oriented to seat the device properly.

13. The drop-on, slide-off mount of claim 8, wherein an audible cue is generated when the adapter plate or base abuts the mounting base and the two latch arms close.

14. The drop-on, slide-off mount of claim 11, wherein a visual cue is displayed when the adapter plate is not engaged with the plunger pin.

15. The drop-on, slide-off mount of claim 8, wherein said latch arms comprise:
two substantially vertical, spaced, parallel walls positioned along respective opposite edges of said mount base to create a channel adapted to retain said adapter plate thereto;
wherein each of said channel walls comprises at least one open end; and
wherein said adapter plate, when secured to said base plate, is slidable across said base plate upper surface along said channel walls past at least one open end to disengage said adapter plate or base from said mount base.

16. The drop-on, slide-off mount of claim 15, wherein said channels guide the adapter plate along the mount base into sliding engagement with the plunger pin.

17. The drop-on, slide-off mount of claim 8, further comprising:
an adjustment mechanism that presses said adapter plate into secure engagement with said latch arms when said adapter plate in seated on said mount base.

18. The drop-on, slide-off mount of claim 11, wherein said latch arms provide vertical retention of the adapter plate to the mount base; and
wherein said plunger pin provides left/right lateral retention of the adapter plate to the mount base.

19. The drop-on, slide-off mount of claim 8, further comprising:
fixed walls that extend substantially vertically along parallel edges of the mount base, wherein said fixed walls are adapted to provide front/rear lateral retention of the adapter plate to the mount base to prevent the adapter plate from pushing laterally on the latch arms and inadvertently opening the latches.
